(19) United States
(12) Patent Application Publication
(10) Pub. No.: US 2025/0008189 A1
(43) Pub. Date: Jan. 2, 2025

(54) Personalized Bandwidth Preservation

(71) Applicant: Rovi Product Corporation, San Jose, CA (US)

(72) Inventors: Govind Raveendranathan Nair, Bengaluru (IN); Mantoo Sinha, Bengaluru (IN); VasanthRaj Rajanna, Bengaluru (IN); Sangeeta Parida, Bengaluru (IN)

(21) Appl. No.: 18/214,867

(22) Filed: Jun. 27, 2023

(51) Int. Cl. H04N 21/472; H04N 21/25

(52) U.S. Cl. CPC H04N 21/47217; H04N 21/251

(57) ABSTRACT

Generally disclosed herein is an approach for identifying unwanted or skipped portions of streaming content and determining additional potential skippable portions from the same streaming content or different streaming content. The skipped portions of the streaming content may be tagged and stored in a database. The database may be updated whenever the streaming content system detects the user skipping certain portions of the streaming content. The streaming content system may modify the next streaming content by removing or shortening the potential skippable portions based on a comparison to the data stored in the database.

### BACKGROUND

In today's abundant media content world, a user may have many options for media content to watch. With the wide variety of options, users tend to skim through the content to find content of interest. Sometimes user watch a portion of content, but then skip another portion of the content. For example, where the content is a musical, the user may skip through portions that are dialogue without music. This may lead to wasted bandwidth and power and other computing resources of both the content provider and the user's media streaming system.

### BRIEF SUMMARY

Generally disclosed herein is a mechanism to automatically determine and analyze a user's pattern of viewing streaming content, including identifying patterns for skipping portions of the streaming content. The patterns may be used to predict portions of subsequent content that the user would likely skip. Accordingly, the next streaming content may be processed to skip clips based on the predictions. By skipping clips based on the predictions, portions of the content can be omitted from streaming and buffering, thereby saving bandwidth, power, memory, etc.

An aspect of the disclosure provides a system for personalizing streaming content. The system comprises one or more processors and memory in communication with the one or more processors, wherein the memory contains instructions configured to cause the one or more processors to monitor a user's activity while the user is viewing a first streaming content. The instructions are also configured to cause the one or more processors to determine whether the user has skipped a first portion of the first streaming content. The instructions are further configured to cause the one or more processors to analyze information of the skipped first portion. The instructions are also configured to cause the one or more processors to store the analyzed information in a database. The instructions are further configured to cause the one or more processors to analyze a second streaming content to detect content attributes. The instructions are also configured to cause the one or more processors to determine, based on the content attributes and the skipped first portion of the first streaming content, to skip a second portion of the second streaming content. The instructions are also configured to cause the one or more processors to automatically skip the second portion of the second streaming content in response to the determining.

In another example, the instructions are configured to cause the one or more processors to generate a tag for the skipped first portion.

In yet another example, the instructions are configured to cause the one or more processors to determine patterns of skippable portions based on the tag.

In yet another example, the instructions are configured to cause the one or more processors to buffer a short clip from the second portion of the second streaming content.

Another aspect of the disclosure provides for a method for personalizing streaming content. The method includes monitoring, by one or more processors, a user's activity while the user is viewing a first streaming content. The method further includes determining, by the one or more processors, whether the user has skipped a first portion of the first streaming content. The method also includes analyzing, by the one or more processors, information of the skipped first portion. The method further includes storing, by the one or more processors, the analyzed information in a database. The method also includes analyzing, by the one or more processors, a second streaming content to detect content attributes. The method further includes determining, by the one or more processors, based on the content attributes and the skipped first portion of the first streaming content, to skip a second portion of the second streaming content. The method also includes automatically skipping, by the one or more processors, the second portion of the second streaming content in response to the determining.

In another example, the method includes generating a tag for the skipped portion.

In yet another example, the method includes determining patterns of skippable portions based on the tag.

In yet another example, the method includes buffering a short clip from the second portion of the second streaming content.

Another aspect of the disclosure provides for a non-transitory machine-readable medium comprising machine-readable instructions encoded thereon for performing a method of personalizing streaming content. The method includes monitoring a user's activity while the user is viewing a first streaming content. The method also includes determining whether the user has skipped a first portion of the first streaming content. The method further includes analyzing information of the skipped first portion. The method also includes storing the analyzed information in a database. The method further includes analyzing a second streaming content to detect content attributes. The method also includes determining based on the content attributes and the skipped first portion of the first streaming content, to skip a second portion of the second streaming content. The method further includes automatically skipping the second portion of the second streaming content in response to the determining.

In another example, the method includes generating a tag for the skipped first portion.

In yet another example, the method includes determining patterns of skippable portions based on the tag.

The above and other aspects of the disclosure can include one or more of the following features. In some examples, aspects of the disclosure provide for all of the following features in combination.

In an example, the patterns of skippable portions are provided to the user for verification.

In another example, the skipping the second portion of the second streaming content includes not streaming the second streaming content.

In yet another example, the skipping the second portion of the second streaming content includes automatically fast-forwarding through the second portion of the second streaming content.

In yet another example, the user is prompted to determine whether or not to skip all of the second portion of the second streaming content after the user completes viewing the short clip.

### BRIEF DESCRIPTION OF THE DRAWINGS

FIG. 1 depicts a block diagram of an example streaming content platform sending the entire packets of the requested content to a user's device according to aspects of the disclosure.

FIG. 2 depicts a block diagram of an example streaming content platform capable of processing the user's skipped portions according to aspects of the disclosure.

FIG. 3 depicts a block diagram of an example streaming content platform notifying a user of a potential skippable portion of the streaming content according to aspects of the disclosure.

FIG. 4 depicts a block diagram of an example streaming content system according to aspects of the disclosure.

FIG. 5 depicts a flow diagram of an example method for generating the user's area of disinterest from the streaming content according to aspects of the disclosure.

FIG. 6 depicts a flow diagram of an example method for sending the modified streaming content according to aspects of the disclosure.

FIG. 7 depicts a block diagram of an example method for determining a potential skippable portion of the subsequent streaming content according to aspects of the disclosure.

### DETAILED DESCRIPTION

The present disclosure provides for identifying unwanted or skipped portions of streamed content, and predicting skippable portions of subsequent streaming content based on the identified unwanted or skipped portions of the streamed content. The skipped portions of the streaming content may be tagged and stored in a database. The database may be updated whenever the streaming content system detects the user skipping certain portions of streaming content. The streaming content system may modify subsequent streaming content by removing or shortening the potential skippable portions.

According to some examples, the streaming content system may receive a streaming content request from a user. Once the streaming content system identifies the requested streaming content, the system may divide the streaming content into several segments. Each segment may be divided according to its contextual information. The divided segments may be analyzed against the user's historical data relating to the skipped portions of the streaming content. If one or more divided segments contain similar portions to the past skipped portions, the system may flag the segments to determine whether to send or block. The portions may be considered similar based on attributes of the content, such as actors, genre, music, dialogue, rating, actions (e.g., violence, dancing, etc.), lighting (e.g., bright, flashing, or strobe lighting), etc. The system will process the segments with the “send” flag and send those segments to the user's device.

In some examples, the system may generate tags for each skipped portion. The system may analyze the content of each of the skipped portions and tag the skipped portions based on the attributes or contextual information such as genre (e.g., action, dialogue, singing scene, etc.) and actors, etc. The streaming content system may generate data associating the tags with preferences for the user, thereby creating a personalized system for the user to skip portions of content based on the user's skipping history. The system may maintain a database for the data and refine it based on additional inputs received.

In some examples, the streaming content system may communicate with a personalized experience server to utilize the database to process the portions of the streaming content to flag each portion as either “send” or “block”. The personalized experience server may be a server that stores the information relating to individual user's skipped portions of certain streaming content. If subsequent streaming content, that has not yet been played by the user, contains clips that are contextually similar to the user's previously skipped content, the subsequent streaming content may be processed to remove those similar clips from streaming queues. The system may stream the rest of the streaming content to the user.

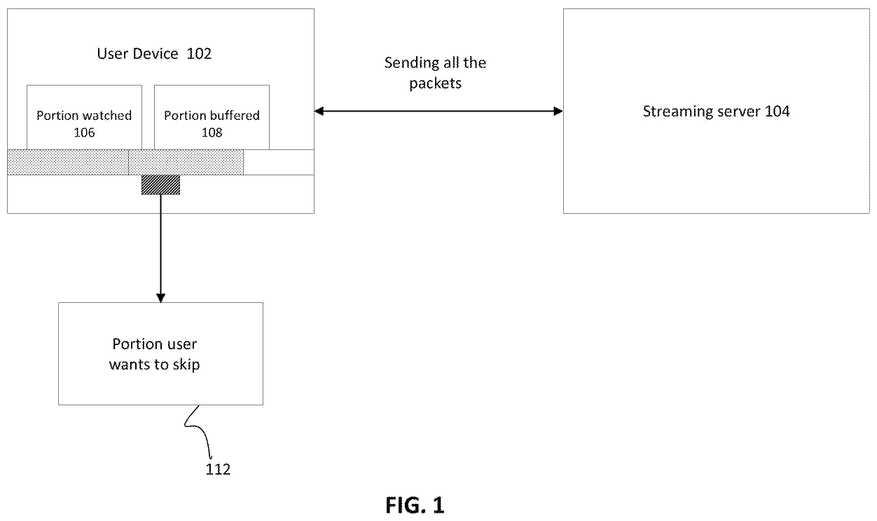

FIG. 1 depicts a block diagram of an example streaming content platform sending the packets of the requested content to a user's device. In one example, a user may view the streaming content using user device 102. User device 102 may display the progress bar representing both portions watched 106 and portion buffered 108. Portion watched 106 may be the portion that the user viewed without fast forwarding or skipping. Portion buffered 108 may include the portion 112 that the user wants to skip. Streaming server 104 may send the entire packets or segments of the streaming content to user device 102. Streaming content may be, for example, series of episodes, one or more movies, a series of podcasts, video clips, etc a. The user may want to skip the portion of the streaming content where the lead character sings. The user may skip the portion because the user simply does not like the musical part. The user may want to skip the portion because the user dislikes a specific genre of music.

In the same example, portion 112 may be the musical part. The user may manually skip portion 112 by moving the playback mark on user device 102. User device 102 may send the information related to the user's skipped portion to streaming server 104, such that streaming server 104 may search the remaining portions of the streaming content to find additional portions similar to portion 112. For example, if the user is viewing a movie where the user has skipped a portion that plays a romantic song, and the movie has seven songs and four out of those seven songs are romantic songs, streaming server 104 may search for the romantic songs and stop streaming the portion that plays the romantic songs. If portion 112 is the first portion playing the first romantic song, streaming server 104 may find three additional portions from the rest of the streaming content and remove such portions from the rest of the streaming content.

User device 102 may include a portable TV player, smartphone, tablet, laptop, smart TV, television with a streaming device, etc. Streaming server 104 may include a web server that may deliver live or on-demand video content to viewers based on a subscription basis.

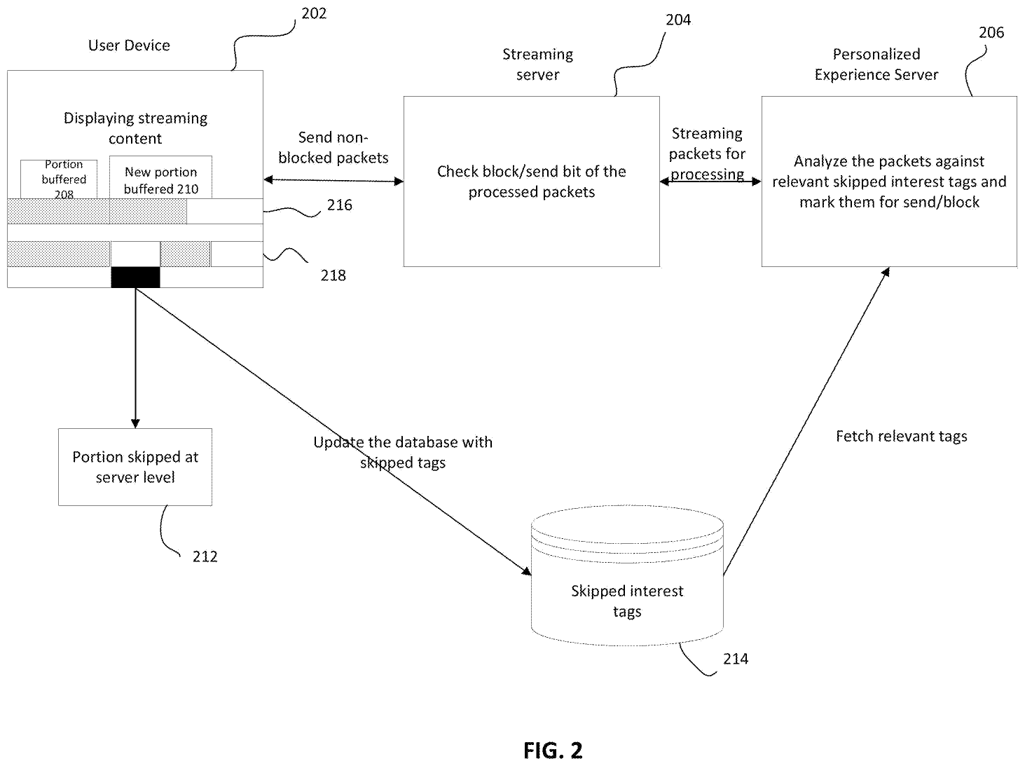

FIG. 2 depicts a block diagram of an example streaming content platform capable of analyzing the user's skipped portions of the streaming content. User device 202 may communicate with streaming server 204. Steaming server 204 may communicate with personalized experience server 206. User device 202 may display modified progress bar 216 and original progress bar 218. Modified progress bar 216 may indicate a modified progress bar based on the analyzed skipped portions of the streaming content. Original progress bar 218 may indicate a portion 212 that was skipped. User device 202 may send the information about the portion skipped 212 to database 214 for storage.

User device 202 may generate and attach tags to each skipped portion and store the portions in database 214. In some examples, database 214 may accumulate information related to one or more tags and generate metadata for the user's general area of disinterest. Such metadata may include certain objects, colors, actors, plot, music, violence or age appropriateness, etc.

Streaming server 204 may monitor the user's activity and analyze if the user has skipped portion 212. For example, streaming server 204 may utilize various devices and sensors such as a camera, voice detector, heat sensor, etc. to detect if the user is skipping certain portions of the content, looking away from the screen, or fast-forwarding through the portions of the content. When the user manually skips portion 212, streaming server 204 detects such activity and sends the information to personalized experience server 206. Personalized experience server 206 may analyze the rest of the streaming content against the information related to portion 212 stored in database 214 and determine whether the rest of the streaming content contains comparable portions.

Personalized experience server 206 may divide the streaming content received from streaming server 204 into multiple segments and determine whether or not to send or block each segment of the streaming content. According to some examples, personalized experience server 206 may determine the dividing points within the streaming content. For example, personalized experience server 206 may divide the streaming content into several segments based on the scenes. In other examples, personalized experience server 206 may divide the streaming content into various segments based on predetermined time intervals (e.g., 5 mins, 10 mins, etc.) In one example, personalized experience server 206 may mark each segment that should or should not be transmitted to the user's device. Marking the segments may include, for example, attaching a “send” flag to the segments that do not contain the portions related to the stored tags. If the segments contain portions with similar context compared to the stored tags, personalized experience server 206 may attach a “block” flag to those segments. Streaming server 204 may receive the flagged segments and process the rest of the streaming content based on the flagged segments. For example, streaming server 204 may remove the segments with the “block” flags from the rest of the streaming content. The modified streaming content may be sent to user device 202. New progress bar 216 may be displayed based on the modified streaming content and new portion buffer 210 may reflect additional portions that have been buffered.

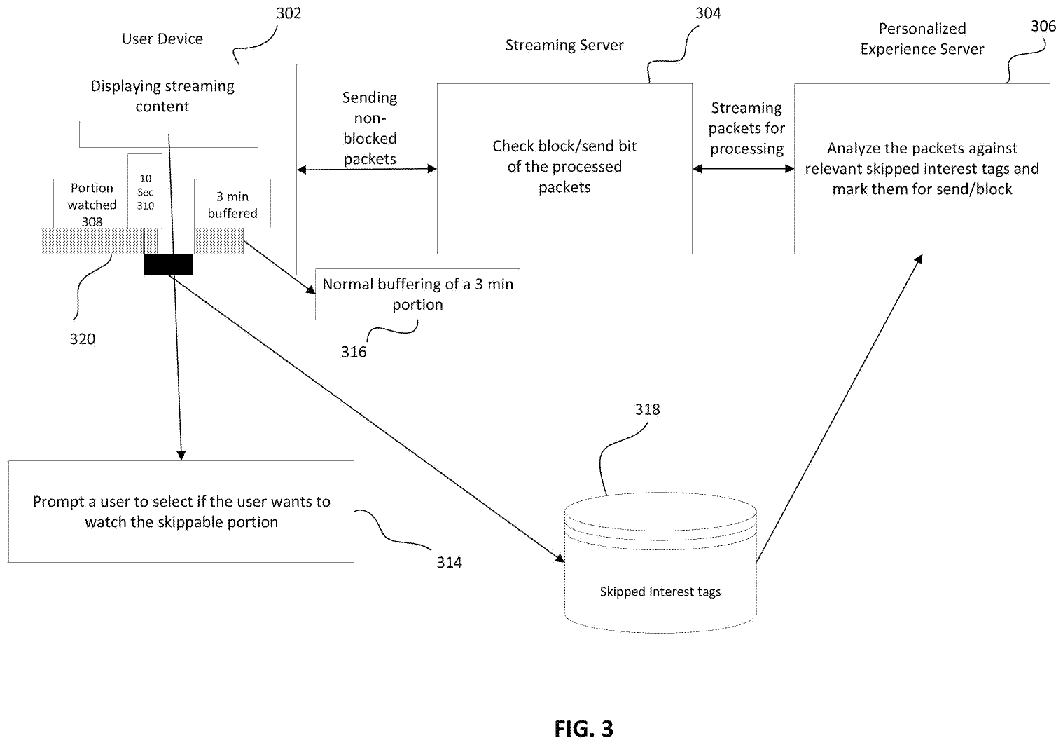

FIG. 3 depicts a block diagram of an example streaming content platform notifying a user of a potential skippable portion of the streaming content. User device 302 may receive the streaming content from streaming server 304. Streaming server 304 may receive processed/modified streaming content from personalized experience server 306. Personalized experience server 306 may analyze each packet or segment against relevant skipped interest tags and make them for “send” flagged or “block” flagged. Skipped interest tags may be received from database 318. Streaming server 304 may check each “send” flagged or “block” flagged segment and only send non “block” flagged packets to user device 302. User device 302 may receive the modified streaming content based on only non “block” flagged segments.

Progress bar 320 may include portion watched 308 and 3 min buffered portion 316. 3 min buffered portion is a normal buffering of a 3-min portion for the “send” flagged segment. Portion 314 may represent the “block” flagged segment. However, streaming server 304 may cause user device 302 to buffer the first 10 seconds of the skippable portion and play the 10-second buffered portion to the user. In some examples, user device 302 may prompt a user to select whether the user wants to skip the entire skippable portion or does not want to skip the skippable portion. If the user elects not to skip the skippable portion, then user device 302 may send such information to database 318 and transmit the segment corresponding to the skipped portion for viewing. According to some examples, because a few second of the segment are already buffered, those few seconds may begin playing while the remainder of the portion is streamed, thereby enabling the user to watch continuously without a glitch and without waiting for additional content to buffer. Personalized experience server 306 may receive the updated information from database 318 based on the user's latest selection. In one example, personalized experience server 306 may delete the tags previously created and stored for the skippable portion. Personalized experience server 306 may also update the information on the user's general area of disinterest.

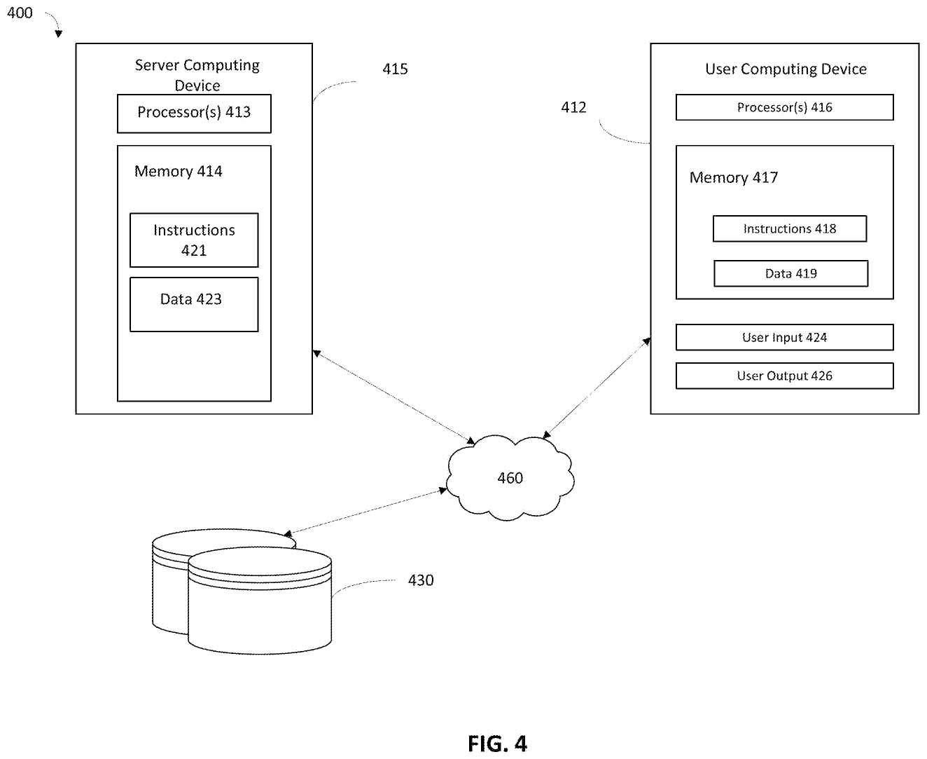

FIG. 4 depicts a block diagram of an example streaming content system. Streaming server 304 and personalized experience server 306 can be implemented on one or more devices having one or more processors in one or more locations, such as in server computing device 415. User device 302 may be implemented on user computing device 412. Database 318 may be implemented on one or more storage devices(s) 430. User computing device 412 and the server computing device 415 can be communicatively coupled to one or more storage devices 430 over a network 460. The storage device(s) 430 can be a combination of volatile and non-volatile memory and can be at the same or different physical locations than the computing devices 412, 415. For example, the storage device(s) 430 can include any type of non-transitory computer-readable medium capable of storing information, such as a hard drive, solid-state drive, tape drive, optical storage, memory card, ROM, RAM, DVD, CD-ROM, write-capable, and read-only memories.

The server computing device 415 can include one or more processors 413 and memory 414. Memory 414 can store information accessible by the processor(s) 413, including instructions 421 that can be executed by the processor(s) 413. Memory 414 can also include data 423 that can be retrieved, manipulated or stored by the processor(s) 413. Memory 414 can be a type of non-transitory computer-readable medium capable of storing information accessible by the processor(s) 413, such as volatile and non-volatile memory. The processor(s) 413 can include one or more central processing units (CPUs), graphic processing units (GPUs), field-programmable gate arrays (FPGAs), and/or application-specific integrated circuits (ASICs), such as tensor processing units (TPUs).

Instructions 421 can include one or more instructions that when executed by the processor(s) 413, causes the one or more processors to perform actions defined by the instructions. Instructions 421 can be stored in object code format for direct processing by the processor(s) 413, or in other formats including interpretable scripts or collections of independent source code modules that are interpreted on demand or compiled in advance. Instructions 421 can include instructions for implementing processes consistent with aspects of this disclosure. Such processes can be executed using the processor(s) 413, and/or using other processors remotely located from the server computing device 415.

The data 423 can be retrieved, stored, or modified by the processor(s) 413 in accordance with instructions 421. Data 423 may include token 401. Data 423 can be stored in computer registers, in a relational or non-relational database as a table having a plurality of different fields and records, or as JSON, YAML, proto, or XML documents. Data 423 can also be formatted in a computer-readable format such as, but not limited to, binary values, ASCII or Unicode. Moreover, data 423 can include information sufficient to identify relevant information, such as numbers, descriptive text, proprietary codes, pointers, references to data stored in other memories, including other network locations, or information that is used by a function to calculate relevant data.

User computing device 412 can also be configured similar to the server computing device 415, with one or more processors 416, memory 417, instructions 418, and data 419. The user computing device 412 can also include a user output 426, and a user input 424. The user input 424 can include any appropriate mechanism or technique for receiving input from a user, such as a keyboard, mouse, mechanical actuators, soft actuators, touchscreens, microphones, and sensors.

Server computing device 415 can be configured to transmit data to the user computing device 412, and the user computing device 412 can be configured to display at least a portion of the received data on a display implemented as part of the user output 426. The user output 426 can also be used for displaying an interface between the user computing device 412 and the server computing device 415. The user output 426 can alternatively or additionally include one or more speakers, transducers or other audio outputs, a haptic interface or other tactile feedback that provides non-visual and non-audible information to the platform user of the user computing device 412.

Although FIG. 4 illustrates the processors 413, 416 and the memories 414, 417 as being within the computing devices 415, 412, components described in this specification, including the processors 413, 416 and the memories 414, 417 can include multiple processors and memories that can operate in different physical locations and not within the same computing device. For example, some of the instructions 421, 418 and the data 423, 419 can be stored on a removable SD card and others within a read-only computer chip. Some or all of the instructions and data can be stored in a location physically remote from, yet still accessible by, the processors 413, 416. Similarly, processors 413, 416 can include a collection of processors that can perform concurrent and/or sequential operations. Computing devices 415, 412 can each include one or more internal clocks providing timing information, which can be used for time measurement for operations and programs run by computing devices 415, 412.

The server computing device 415 can be configured to receive requests to process data from the user computing device 412. For example, environment 400 can be part of a computing platform configured to provide a variety of services to users, through various user interfaces and/or APIs exposing the platform services. One or more services may be online multi-user event participation. The user computing device 412 may receive and transmit data related to an online multi-user event participants' state, profile information, historical data, etc.

Devices 412, 415 can be capable of direct and indirect communication over network 460. Devices 412, 415 can set up listening sockets that may accept an initiating connection for sending and receiving information. The network 460 itself can include various configurations and protocols including the Internet, World Wide Web, intranets, virtual private networks, wide area networks, local networks, and private networks using communication protocols proprietary to one or more companies. Network 460 can support a variety of short- and long-range connections. The network 460, in addition, or alternatively, can also support wired connections between devices 412, 415, including various types of Ethernet connection.

Although a single server computing device 415 and user computing device 412 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

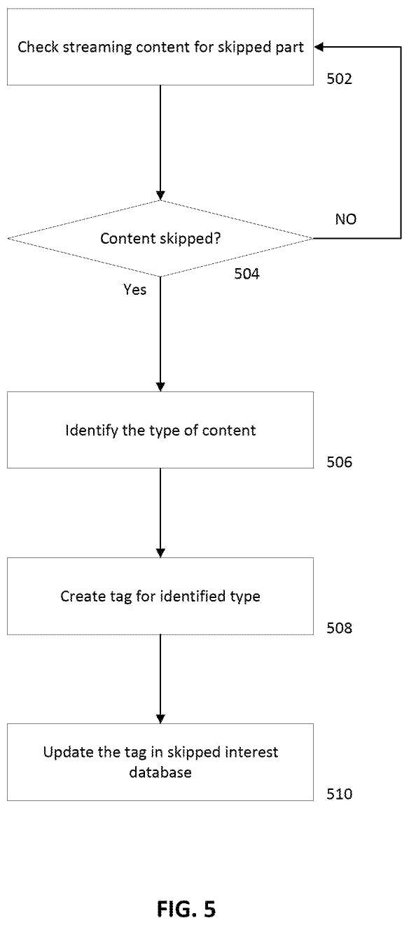

FIG. 5 depicts a flow diagram of an example method for generating the user's area of disinterest in the streaming content. According to block 502, a user device may check or monitor the user's activities to determine whether the user is skipping any portions of the streaming content. For example, if a user is viewing the first episode of a television series on the user's smartphone and the user wants to skip a portion of the episode where the actors battle, the user's device may send the information to the streaming content server when the user actually skip the streaming content. According to block 504, if the user skips a certain portion of the episode, the step proceeds to block 506. If the user does not skip any portions of the episode, the step proceeds back to block 502.

According to block 506, the streaming content server may analyze the information received from the user device regarding the skipped portion of the episode. The streaming content server may analyze the skipped portion and identify the context of the skipped portion. For example, the streaming content server may identify which actors were battling, what kind of battle the actors were engaged in, the violence level, the types of the battle (e.g., group battle, 1 vs 1 battle, etc.), the length of the battle, the style of the battle (sword, gun, martial arts, etc.) and the loudness of the sound from the battle, etc. According to block 508, the streaming content server, the streaming content server may generate tags for the identified contextual information of the skipped portion of the episode. Such a tag may comprise a unique identifier value assigned based on the predetermined categories of different contexts associated with each porin of the TV series episode. For example, the first tag may be associated with information about actors, and the second tag may be associated with a genre of the TV series episode, the third tag may be associated with the violence level and age appropriateness of a particular scene within the TV series episode.

According to block 510, the streaming content server may update the user's skipped interest database. The skipped interest database may store the user's activity and profile information. The user's activity and profile information may contain the user's historic data of the skipped portion. The newly generated tags in block 508 may be added as a new dataset or used to update the previously stored dataset related to similar contextual information.

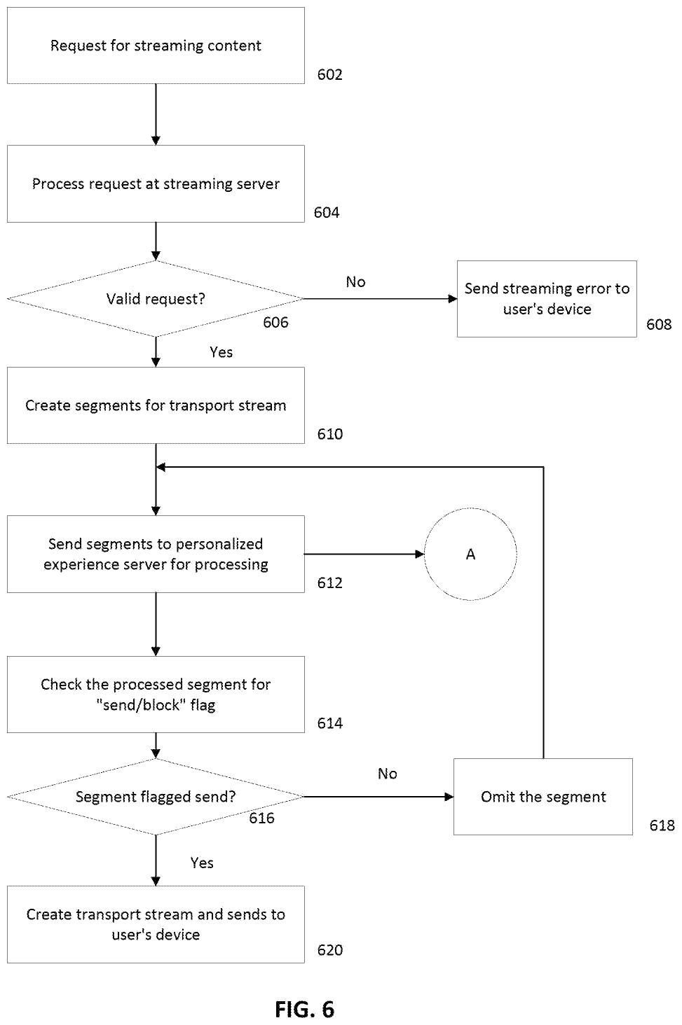

FIG. 6 depicts a flow diagram of an example method for sending the modified streaming content. According to block 602, the streaming content server may receive a request for the streaming content. The user's device may comprise a smartphone, smart TV, tablet, or laptop. A user may download a streaming application and request streaming content using the application. Once the user makes the request, the user device may send the request to the streaming content server. According to block 604, the streaming content server may process the request and retrieve the requested streaming content from the server database. According to block 606, the streaming content server may determine whether the request is valid. If the streaming content server determines that the request is valid, the step proceeds to block 610. If the streaming content server determines that the request is not valid, the step proceeds to block 608. The streaming content server 604 may determine the validity of the request based on the user's profile and the user's subscription account. In some examples, the user device may capture the user's biometric data using a facial recognition technique and send such information to the streaming content server for validation. According to block 608, the streaming content server may send an error notification to the user device.

According to block 610, the streaming content server may generate segments from the streaming content. The streaming content server may divide the streaming content into several segments based on each segment's contextual information. For example, the streaming content server may divide the streaming content based on the frequency and length of the appearances of certain actors in particular scenes. According to block 612, the streaming content server may send the segments to the personalized experience server. The personalized experience server may flag each segment as either “send” or “block and send information back to the streaming content server. The streaming content server may check the processed segment for the “send” or “block” flag.

According to block 614, the streaming content server may modify the remaining portions of the streaming content based on the flag information and remove the segment with the “block” flag from the rest of the streaming content. According to some examples, the streaming content server may transmit the first few seconds of the portions with the block” flag, such that the user may determine whether to skip or continue viewing the rest of the portions with the “block” flag. According to block 616, the streaming content server may determine whether the segment has the “send” flag before being sent to the user's device. If the segments do not have the “send” flags, the segments may be discarded at block 618. If the segments with the “send” flags are sent, the streaming content server may send to the user device at block 620.

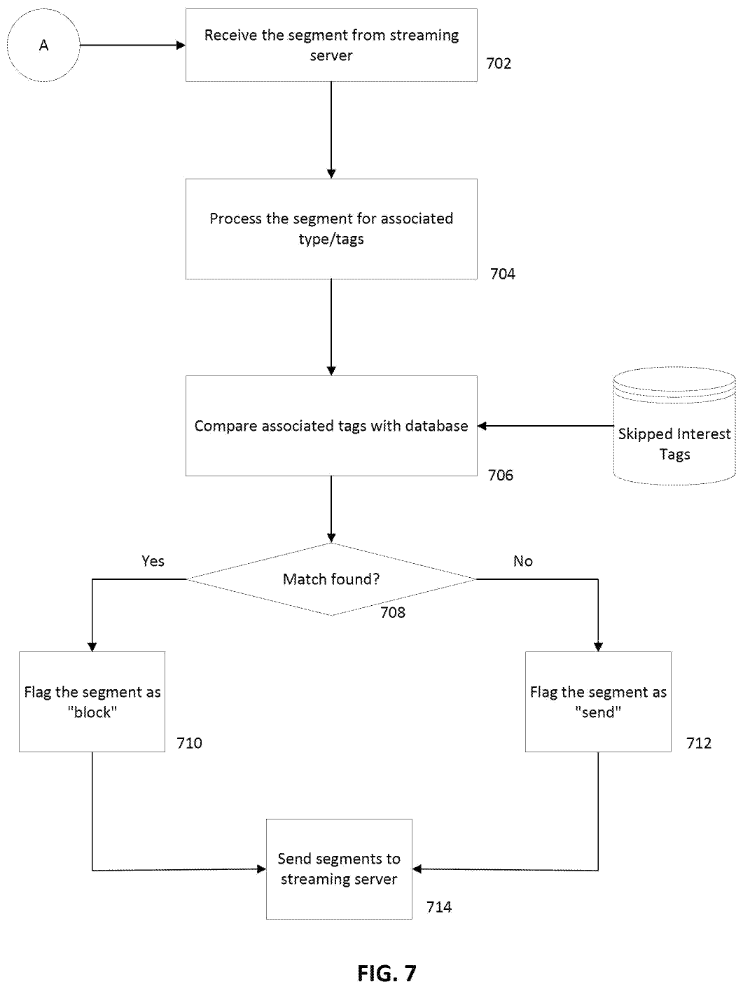

FIG. 7 depicts a block diagram of an example method for determining a potential skippable portion of the subsequent streaming content. According to block 702, the personalized experience server may receive the segments from the streaming content server. In one example, the streaming content may be divided into segments by the streaming content server based on the historic preference data contained in the user's profile. In other examples, the streaming content server may divide the streaming content into various segments using a machine learning model. The machine learning model may be trained using the historic preference data of the user. According to block 704, the personalized experience server may process the received segments to determine the types and tags associated with each segment. If the segments have the attached tags, the personalized experience server may compare the associated tags with the information stored in the database at block 706. For example, the database has the stored information of the historic preference data of the user profile. The database may contain information on what types of scenes the user may have skipped in the past. The user may have skipped portions containing an actor's signing. If any match is found at block 708, the step proceeds to block 710 and the personalized experience server may flag the respective segment as “block” and attach a “block” flag. If no match is found, the step proceeds to block 712 and the personalized experience server may assign “send” flags to the segments. According to block 714, the personalized experiences server may send segments with both “flag” and “send” flags to the streaming content server.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for personalizing streaming content, the system comprising:
one or more processors; and
memory in communication with the one or more processors, wherein the memory contains instructions configured to cause the one or more processors to:
monitor a user's activity while the user is viewing a first streaming content;
determine whether the user has skipped a first portion of the first streaming content;
analyze information of the skipped first portion;
store the analyzed information in a database;
receive second streaming content;
divide the second streaming content into a plurality of segments based on contextual information;
analyze each segment of the plurality of segments to detect content attributes;
determine, based on a comparison of the content attributes and the skipped first portion of the first streaming content, to skip one or more of the plurality of segments of the second streaming content; and
automatically skip the one or more segments of the plurality of segments of the second streaming content in response to the determining.

2. The system of claim 1, wherein the instructions cause the one or more processors to generate a tag for the skipped first portion.

3. The system of claim 2, wherein the instructions cause the one or more processors to determine patterns of skippable portions based on the tag.

4. The system of claim 3, wherein the patterns of skippable portions are provided to the user for verification.

5. The system of claim 1, wherein the skipping the second portion of the second streaming content includes removing the one or more segments of the plurality of segments from the second streaming content prior to playing back the second streaming content.

6. The system of claim 1, wherein the skipping the second portion of the second streaming content includes automatically fast-forwarding through the second portion of the second streaming content.

7. The system of claim 1, wherein the instructions cause the one or more processors to buffer a short clip from the second portion of the second streaming content.

8. The system of claim 7, wherein the user is prompted to determine whether or not to skip all of the second portion of the second streaming content after the user completes viewing the short clip.

9. A method for personalizing streaming content, the method comprising:
monitoring, by one or more processors, a user's activity while the user is viewing a first streaming content;
determining, by the one or more processors, whether the user has skipped a first portion of the first streaming content;
analyzing, by the one or more processors, information of the skipped first portion;
storing, by the one or more processors, the analyzed information in a database;
receiving, by the one or more processors, second streaming content;
dividing, by the one or more processors, the second streaming content into a plurality of segments based on contextual information;
analyzing, by the one or more processors, each segment of the plurality of segments to detect content attributes;
determining, by the one or more processors, based on a comparison of the content attributes and the skipped first portion of the first streaming content, to skip one or more of the plurality of segments of the second streaming content; and
automatically skipping, by the one or more processors, the one or more segments of the plurality of segments of the second streaming content in response to the determining.

10. The method of claim 9, further comprising generating a tag for the skipped first portion.

11. The method of claim 10, further comprising determining patterns of skippable portions based on the tag.

12. The method of claim 11, wherein the patterns of skippable portions are provided to the user for verification.

13. The method of claim 9, wherein the skipping the second portion of the second streaming content includes removing the one or more segments of the plurality of segments from the second streaming content prior to playing back the second streaming content.

14. The method claim 9, wherein the skipping the second portion of the second streaming content includes automatically fast-forwarding through the second portion of the second streaming content.

15. The method of claim 9, further comprising buffering a short clip from the second portion of the second streaming content.

16. The method of claim 15, wherein the user is prompted to determine whether or not to skip all of the second portion of the second streaming content after the user completes viewing the short clip.

17. A non-transitory machine-readable medium comprising machine-readable instructions encoded thereon for performing a method of personalizing streaming content, the method comprising:
monitoring a user's activity while the user is viewing a first streaming content;
determining whether the user has skipped a first portion of the first streaming content;
analyzing information of the skipped first portion;
storing the analyzed information in a database;
receiving second streaming content;
dividing the second streaming content into a plurality of segments based on contextual information;
analyzing each segment of the plurality of segments to detect content attributes;
determining based on a comparison of the content attributes and the skipped first portion of the first streaming content, to skip one or more of the plurality of segments of the second streaming content; and
automatically skipping the one or more segments of the plurality of segments of the second streaming content in response to the determining.

18. The non-transitory machine-readable medium of claim 17, further comprising generating a tag for the skipped first portion.

19. The non-transitory machine-readable medium of claim 18, further comprising determining patterns of skippable portions based on the tag.

20. The non-transitory machine-readable medium of claim 19, wherein the patterns of skippable portions are provided to the user for verification.
